(19) United States
(12) Patent Application Publication
(10) Pub. No.: US 2013/0285876 A1
(43) Pub. Date: Oct. 31, 2013

(54) DUAL BAND ANTENNA WITH CIRCULAR POLARIZATION

(71) Applicant: National Taiwan University of Science and Technology, (US)

(72) Inventors: SHIH-HSUN CHANG, Taipei (TW); WEN-JIAO LIAO, Taipei (TW)

(73) Assignee: National Taiwan University of Science and Technology, Taipei (TW)

(21) Appl. No.: 13/785,140

(22) Filed: Mar. 5, 2013

(30) Foreign Application Priority Data
Apr. 27, 2012 (TW) 101115090

(51) Int. Cl. H01Q 5/01

(52) U.S. Cl. CPC H01Q 5/01
USPC 343/860; 343/700 MS

(57) ABSTRACT

A dual band antenna with circular polarization is applied in a handheld device and includes a substrate, a radiation metal portion and a feed-in stripline. The substrate has a vacant area and a feed-in point. The feed-in point is disposed near and outside the vacant area. The radiation metal portion is disposed vertically to a surface of the substrate at the edge of the vacant area, and includes a radiation surface and a meandering structure. The radiation surface is disposed at one side of the radiation metal portion and near the substrate. The meandering structure is disposed at another side of the radiation metal portion and far from the substrate. The feed-in stripline is disposed on the substrate. One end of the feed-in stripline is electrically connected to the feed-in point, and the other end of the feed-in stripline is electrically connected to the radiation metal portion.

### BACKGROUND OF THE INVENTION

(1) Field of the Invention

The invention relates to a dual band antenna with circular polarization, and especially relates to a dual band antenna with circular polarization for handheld navigation and positioning apparatus having Global Positioning System (GPS).

(2) Description of the Prior Art

The Global Positioning System (GPS) navigation and positioning device is the rapid development of products in the past decade, thus, making it a considerable scale and complete product line in market. In addition to the U.S. Global Positioning System (GPS) system, the other also include: bands such as E5a band (1.176 GHz), E5b band (1.207 GHz), E6-band (1.278 GHz) and E1 band (1.575 GHz) of the European Union Galileo positioning system; and bands such as band L1 (1.602 GHz) and band L2 (1.246 GHz) of Russia's global Navigation Satellite System (GLONASS); and bands such as band E1 (1.589 GHz), band E2 (1.561 GHz), band E6 (1.268 GHz) and band E5b (1.207 GHz) in mainland China Beidou (COMPASS) navigation system. As for the U.S. Global Positioning System (GPS) system, in addition to the original open band L1 (1.575 GHz), in order to maintain the commercial competitive advantage, additional open band L2 (1.227 GHz) and band L5 (1.176 GHz).

Therefore, hand-held navigation and positioning device often requires installation of an effective antenna, in order to take full advantage of multi-band multi-system. In addition, with the development of wireless communication, wireless LAN system in the integration of global satellite positioning system, arising the hand-held navigation and positioning device not only more diverse, but also more dual-band operation results of the antenna. It can use algorithm to reduce positioning errors caused by the atmosphere ionosphere. These include hand-held communication apparatus, personal digital assistants and laptop computers, and the product is constantly in pursuit of miniaturization. Therefore, the antenna signal coupled and transceiver, and the size and appearance of products are becoming the critical of the antenna design considerations.

However, the generally circular polarized antenna in current market is usually occupied a great volume of space in hand-held navigation and positioning device, or use more expensive high-dielectric substrate to shrink its size. The common antenna having built-in and polarization characteristics, most of them are expensive ceramic patch antenna or external cantilevered spiral antenna, its advantages are free from the influence of the use of space, but do not have dual-band operating results. Therefore, if it want to increase its operating band, it must add the additional antenna or changes in architecture, thus it is disadvantageous to the built-in handheld navigation and positioning device. Therefore, in order to fully utilize the advantages of multi-band multi-system, how to providing a dual band antenna with circular polarization for handheld navigation and positioning device, make it has the advantages of small size and built-in which, and has dual band operation and circularly polarized operation capability, is this technology anxious to solve the problem.

### SUMMARY OF THE INVENTION

The purpose of the invention is to provide a dual band antenna with circular polarization. The invention achieves dual-band operation results by a vacant area disposed on a substrate and a meandering structure disposed on a radiation metal portion. The impedance matching and radiation efficiency on the resonant mode of the dual band antenna is more effective for circularly polarization.

The another purpose of the invention is to provide the structural size and design of a dual band antenna with circular polarization, it can effectively save the space occupied of the antenna on a handheld apparatus, in order to built in the handheld apparatus.

In order to achieve one of the above or a part or all of the purposes or other purposes, a dual band antenna with circular polarization in an embodiment includes a substrate, a radiation metal portion and a feed-in stripline. The substrate has a vacant area and a feed-in point. The feed-in point is disposed outside the vacant area and near the edge of a vacant area.

The radiation metal portion is disposed vertically to a surface of the substrate at an edge of the vacant area. The radiation metal portion has a radiation surface and a meandering structure. The radiation surface is disposed at one side of the radiation metal portion near the substrate. The meandering structure is disposed at another side of the radiation metal portion far from the substrate. The meandering structure is meandered in the shape of a paper clip, and includes a first line segment, a second line segment, a third line segment, a first connecting segment and a second connecting segment. The first line segment, the second line segment and the third line segment are mutually parallel. The first line segment and the second line segment are interconnected with the first connecting segment. The second line segment and the third line segment are interconnected with the second connecting segment. The third line segment is disposed between the first line segment and the second line segment.

The feed-in stripline is disposed on the substrate. One end point of the feed-in stripline is electrically connected to the feed-in point, the other end point of the feed-in stripline is electrically connected to the radiation metal portion.

In another embodiment, the substrate is substantially rectangular and has two first long sides parallel to each other and two first short sides parallel to each other. The vacant area is a rectangular area located in the corner of the substrate. The rectangular area has two second long sides parallel to each other and two second short sides parallel to each other. The two first long sides are parallel to the two second long sides, while the two first short sides are parallel to the two second short sides. The length of the second long side of the vacant area is ranged from 30 cm to 50 cm, and the length of the second short side is ranged from 8 cm to 15 cm. The effect of dual band operation and the impedance matching at the resonant modes of the dual band antenna with circular polarization can be controlled by adjusting the size of the vacant area.

In another embodiment, the substrate is a circuit board. A bottom surface of the circuit board has a ground metal layer. The ground metal layer does not overlap with the vacant area. The feed-in point is disposed on an upper surface of the circuit board opposite to the ground metal layer.

In another embodiment, the meandering structure has a slit and is meandered in the shape of a paper clip. The slit is meandered along with the meandering direction of the meandering structure and forms an opening at the edge of the radiation metal portion, and thereby separate the first line segment and the second line segment and the third line segment with the slit. The meandering structure is disposed on the radiation metal portion opposite to an upper edge of the substrate. The meandering structure has a total meandering length. The total meandering length is equal to the sum of the lengths of the first line segment, the second line segment, the third line segment, the first connecting segment and the second connecting segment. The resonant frequency of a dual band antenna with circular polarization can be controlled by adjusting the total meandering length.

In another embodiment, the meandering structure is meandered in a clockwise direction to form a paper clip shape, so as to enable a dual band antenna with circular polarization to be used for the left rotation polarized.

In another embodiment, the meandering structure is meandered in a counterclockwise direction to form a paper clip shape, so as to enable the dual band antenna with circular polarization to be used for the right rotation polarized.

In another embodiment, the feed-in stripline has a width and a length. The dual band antenna with circular polarization can be operated on the first frequency band and the second frequency band. The impedance matching effect of the first frequency band and the second frequency band can be controlled by adjusting the width and the length.

### BRIEF DESCRIPTION OF THE DRAWINGS

FIG. 1 is a three-dimensional structure schematic of a dual band antenna with circular polarization of an embodiment.

FIG. 2 is a look-up plan of a dual band antenna with circular polarization of an embodiment.

FIG. 2A is a side enlarged schematic of the first embodiment of a radiation metal portion in FIG. 2.

FIG. 2B is a side enlarged schematic of the second embodiment of a radiation metal portion in FIG. 2.

FIG. 3 is a look-up plan of a dual band antenna with circular polarization of another embodiment.

FIG. 4 is a curve diagram obtained by measuring a dual band antenna with circular polarization in FIG.2 and FIG.2A.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

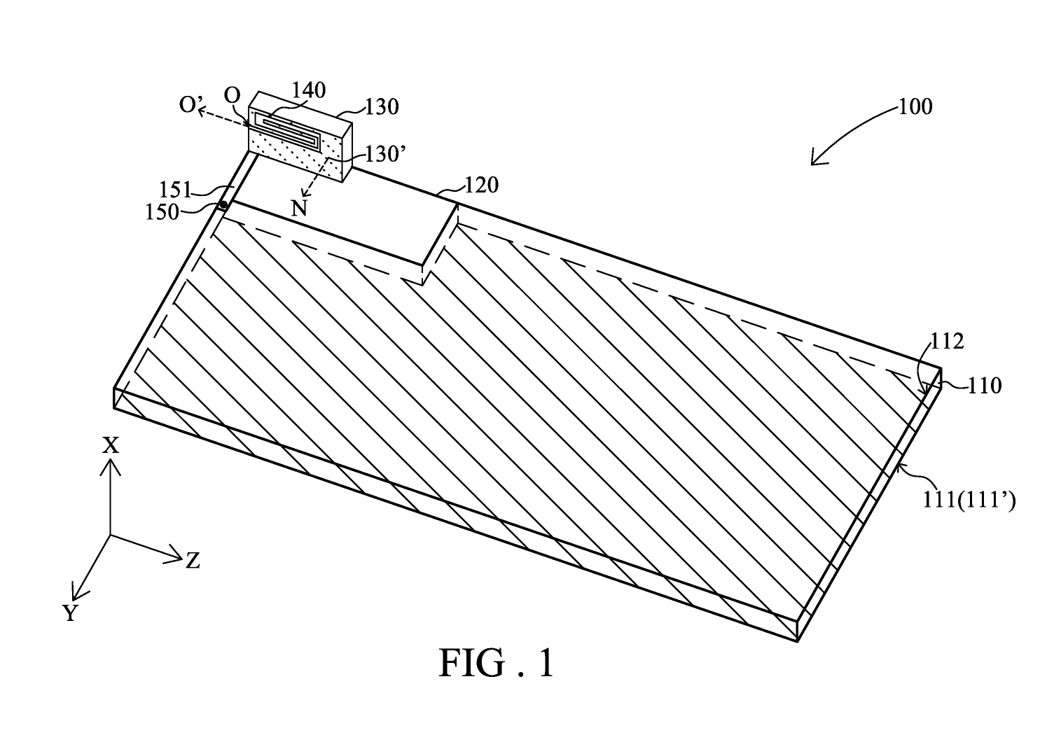

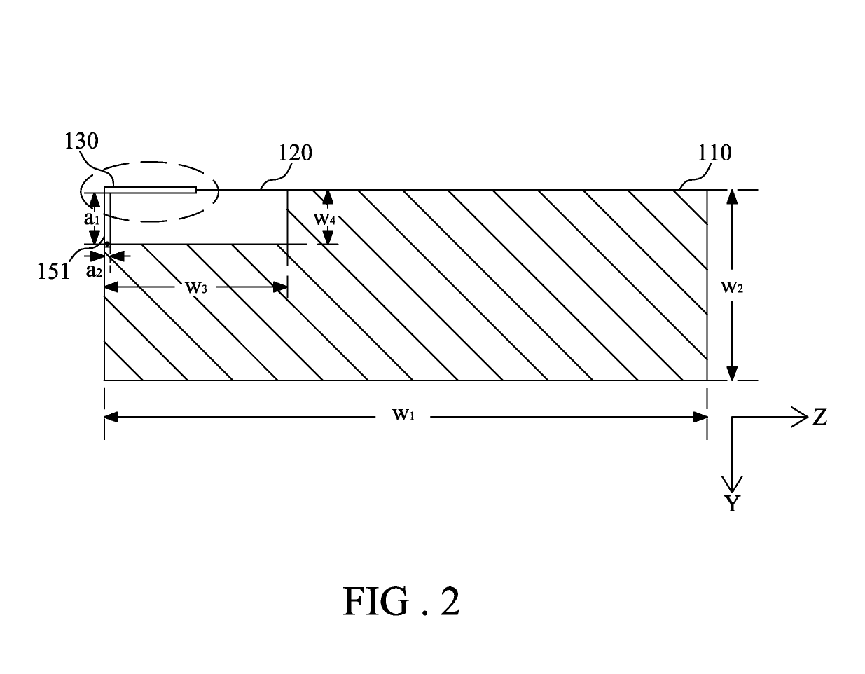

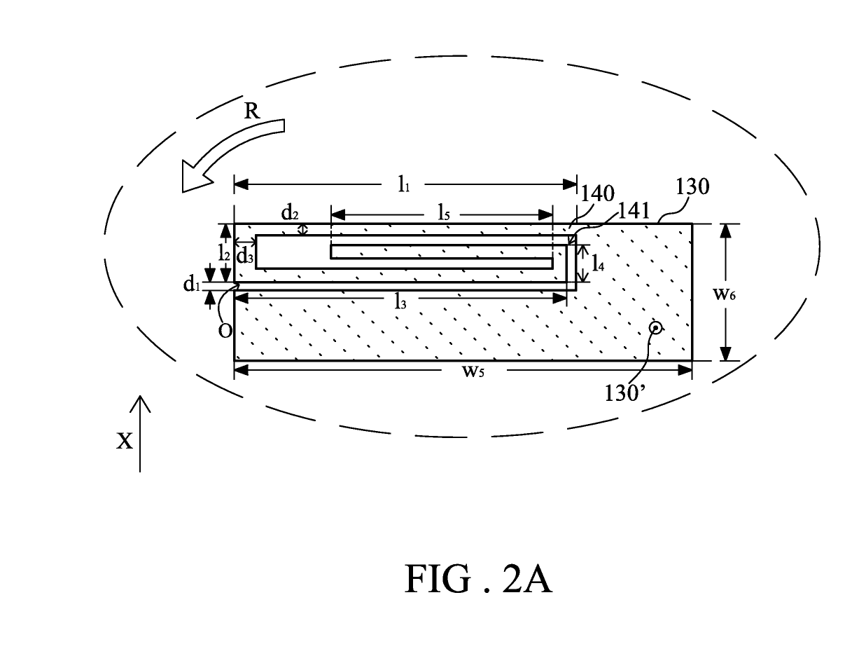

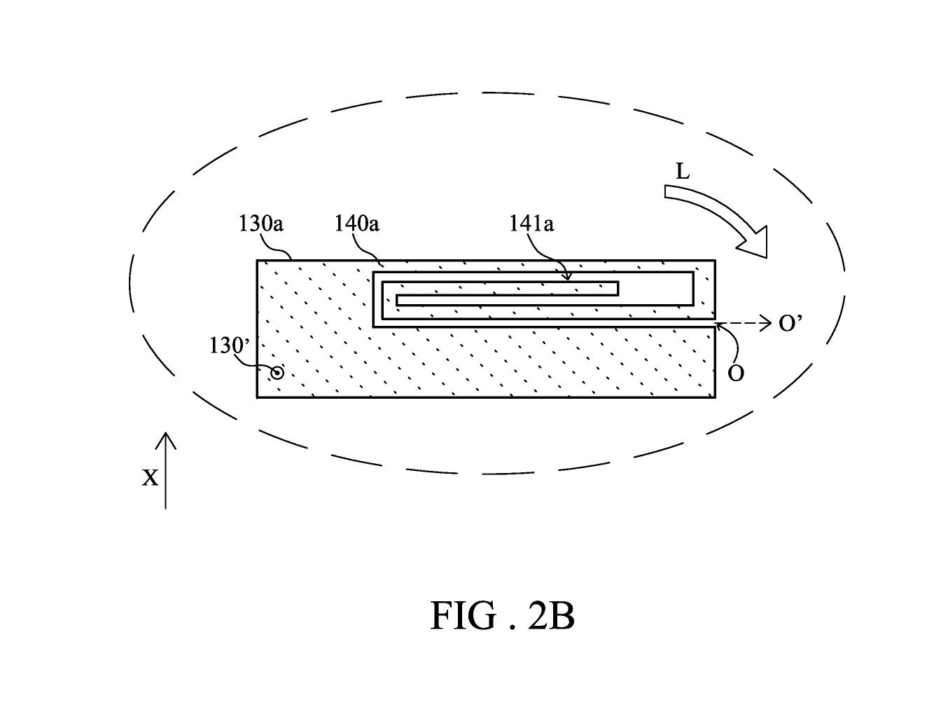

FIGS. 1 and 2 are respectively a three-dimensional structure schematic and a look-up plan of a dual band antenna with circular polarization of an embodiment. A dual band antenna with circular polarization 100 is applied in a handheld device and includes a substrate 110, a radiation metal portion 130 and a feed-in stripline 151. The substrate 110 has a vacant area 120. The substrate 110 is a circuit board; the circuit board is, for example, made of fiber glass FR4. A bottom surface 111 of the circuit board 110 has a ground metal layer 111′, the ground metal layer 111′ is not overlapped with the vacant area 120. The substrate 110 has a feed-in point 150, and the feed-in point 150 is disposed on the upper surface 112 of the circuit board 110. The upper surface 112 is located at the backside of the ground metal layer 111, and the feed-in point 150 is disposed outside the vacant area 120.

In an embodiment, the substrate 110 is substantially rectangular, and the vacant area 120 is a rectangular area disposed in a corner of the substrate 110. The substrate 110 has two first long sides w₁ and two first short sides w₂, the rectangular area 110 has two second long sides w₃ and two second short sides w₄. The two first long sides w₁ are parallel to the two second long sides w₃, while the two first short sides w₂ are parallel to the two second short sides w₄. The two second long sides w₃ of the vacant area 120 are ranged from 30 cm to 50 cm in length. And the two second short sides w₄ are ranged from 8 cm to 15 cm in length. In particular, the vacant area 120 is disposed on the substrate 110, in order to enable the radiation metal portion 130 to maintain a effective radiation efficiency. Besides, it may also control the effect of dual band operation and the impedance matching and radiation efficiency at the resonant modes of a dual band antenna with circular polarization 100 by adjusting the size of the vacant area 120. And, the dual band antenna with circular polarization 100 may be operated on the first frequency band and the second frequency band.

In the embodiment, it define the schematic on top, down, left and right direction by a three-axis X, Y, and Z. The radiation metal portion 130 has a radiation surface 130′ and a meandering structure 140, the radiation metal portion 130 is disposed on the edge of the vacant area 120. The radiation surface 130′ is vertical to the surface of the vacant area 120 and toward the inside of the substrate 110, and the normal N of the radiation surface 130′ is toward to the positive Y-axis direction, that is, the meandering direction of the radiation surface 130′ is parallel to the meandering direction of the second long side w₃ of the vacant area 120. The normal N direction of the substrate 110 and the vacant area 120 is toward the positive X-axis direction.

FIG. 2A is a side enlarged schematic of the first embodiment of the radiation metal portion 130 in FIG. 2. The meandering structure 140 is disposed by the side of the radiation metal portion 130 and meandered in the shape of a paper clip. The meandering structure 140 includes a first line segment l₁, a second line segment l₃, a third line segment l₅, a first connecting segment l₂ and a second connecting segment l_{4.} The first line segment l₁, the second line segment l₃ and the third line segment l₅ are mutually parallel. And the first line segment l₁ and the second line segment l₃ are interconnected with the first connecting segment l₂. The second line segment l₃ and the third line segment l₅ are interconnected with the second connecting segment l₄. The third line segment l₅ is disposed between the first line segment l₁ and the second line segment l₃. The meandering structure 140 has a slit 141. The slit 141 is meandered along with the meandering direction of the meandering structure 140 and forms an opening 0 on the edge of the radiation metal is portion 130. Thereby, the first line segment l₁ and the second line segment l₃ and the third line segment l₅ are separated with the slit 141.

The meandering structure 140 has a total meandering length, the total meandering length is equal to the sum of the lengths of the first line segment l₁, the second line segment l₃, the third line segment l₅, the first connecting segment l₂ and the second connecting segment l₄. In particular, it can control the resonant frequency of the dual band antenna with circular polarization 100 by adjusting the total meandering length.

A feed-in stripline 151 is disposed on the substrate 110, an end point of the feed-in stripline 151 is electrically connected to the feed-in point 150, and another end point of the feed-in stripline 151 is electrically connected to the radiation metal portion 130. The feed-in stripline 151 has a length a₁ and a width a₂, it can control the resonant modes of the dual band antenna with circular polarization 100, by adjusting the length a₁ and the width a₂ of the feed-in stripline 151. In addition, the dual band antenna with circular polarization 100 can be operated on the first frequency band and the second frequency band, so it can control the impedance matching effect of the first frequency band and the second frequency band by adjusting the length a₁ and the width a₂ of the feed-in stripline 151.

In an embodiment, the feed-in stripline 151 is vertically connected to the radiation metal portion 130, so as to enable the meandering direction of the feed-in stripline 151 parallel to the normal N of the radiation surface 130′, and also parallel to the second short side w₄ and vertical to the second long side w₃.

Refer to FIGS. 1 and 2A, the meandering structure 140 is disposed on the radiation metal portion 130, slightly left edge of the upper side relative to the substrate 110. The opening direction O′ of the opening O on the meandering structure 140 is parallel to the first long side w₁ of the substrate 110. The opening direction O′ is toward outside the substrate 110, and make the meandering structure 140 meandered in a counterclockwise direction R to form a paper clip shape, so as to enable the dual band antenna with circular polarization 100 to be used for the right rotation polarized.

Refer to FIG. 2B, is a side enlarged schematic of the second embodiment of a radiation metal portion in FIG. 2. The meandering structure 140 is disposed on the radiation metal portion 130, slightly right edge of the upper side relative to the substrate 110. The opening direction O′ of the opening O on the meandering structure 140 is parallel to the first long side w₁ of the substrate 110. The opening direction O′ is toward inside the substrate 110, and make the meandering structure 140 meandered in a clockwise direction L to form a paper clip shape, so as to enable the dual band antenna with circular polarization 100 to be used for the left rotation polarized.

According to the above embodiment, the current direction of the dual band antenna with circular polarization 100 may be operated effectively, by the designed meandering structure 140 on the radiation metal portion 130, then achieving the purpose of circular polarization. Besides, circular-polarization operation make use of the meandering structure 140, the characteristics of the electric field with orthogonal mode caused by the vacant area 120, the total meandering length of the meandering structure 140 and the size of the vacant area 120, in order to control the current amplitude and the current path length of the dual band antenna with circular polarization 100, then, achieving the purpose of the desired frequency band impedance matching and circular polarization in the same time.

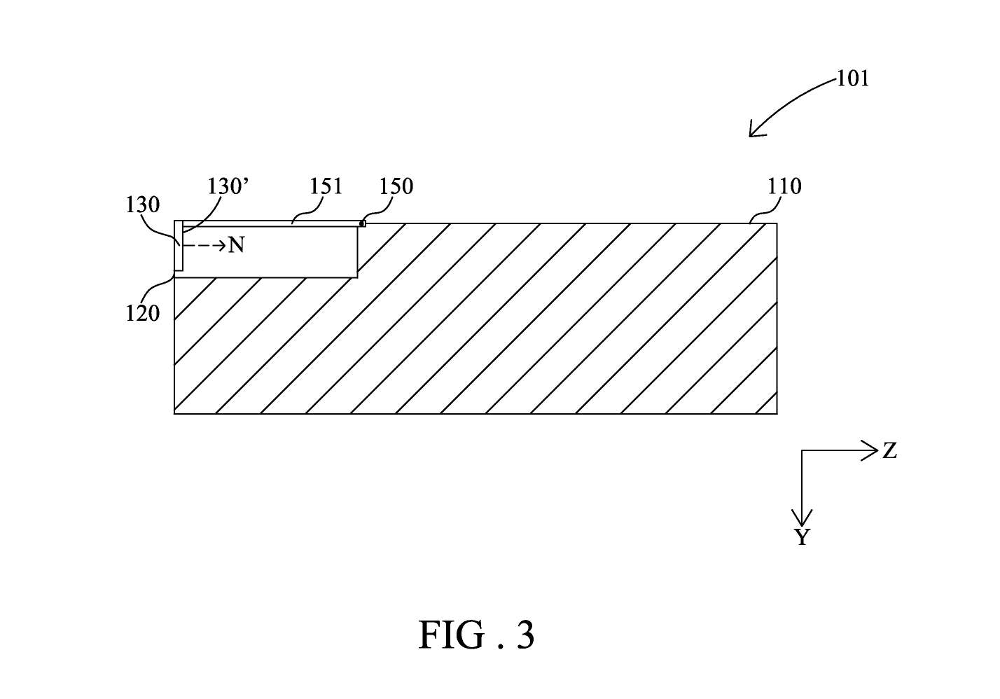

FIG. 3 is a look-up plan of a dual band antenna with circular polarization of another embodiment. A dual band antenna with circular is polarization 101 is applied in a handheld device and includes a substrate 110, a radiation metal portion 130 and a feed-in stripline 151.

The substrate 110 has a vacant area 120 and a feed-in point 150, and the feed-in point 150 is disposed outside the vacant area 120 and near the edge of the vacant area 120. The radiation metal portion 130 has a radiation surface 130′ and a meandering structure (not shown). The radiation metal portion 130 is disposed inside the vacant area 120 and on the edge of the vacant area 120. The radiation surface 130′ is vertical to the surface of the vacant area 120, and toward inside the substrate 110. The normal N of the radiation surface 130′ is toward the positive Z axis direction, that is, the meandering direction of the radiation surface 130′ is parallel to the meandering direction of the second short side of the vacant area 120. The meandering structure 140 has an opening; the meandering direction of the opening is parallel to the meandering direction of the second short side of the vacant area 120.

The radiation metal portion 130 and the feed-in point 150 is electrically connected via a feed-in stripline 151. The meandering direction of the feed-in stripline 151 is parallel to the normal N of the radiation surface 130′. The meandering direction of the feed-in stripline 151 is vertical to the second short side w₄ and parallel to the second long side w₃.

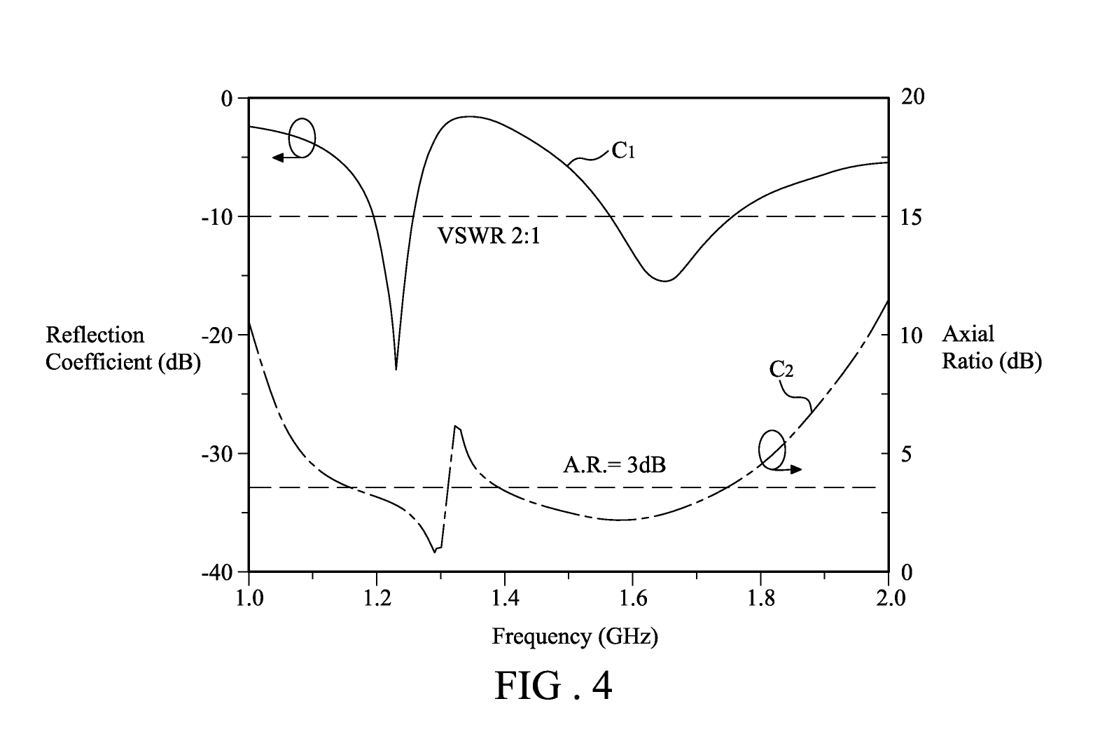

FIG. 4 is a curve diagram obtained by measuring the dual band antenna with circular polarization in FIG.2 and FIG.2A. In the embodiment, the length of the first long side w₁ of the substrate 110 is 120 cm, the length of the first short side w₂ is 67 cm; the length of the second long side w₃ of the vacant area 120 is 40 cm, the length of the second short side w₄ is 12 cm; the long side w₅ of the radiation metal portion 130 is 20 cm, the short side w₆ of the radiation metal portion 130 is 6 cm; the length of the first line segment l₁ of the meandering structure 140 is 15 cm and the width d₂ is 0.5 cm, the length of the second line segment l₃ is 14 cm, the length of the third line segment l₅ cm is 10 cm, the length of the first connecting segment l₂ is 2.5 cm and the width of d₃ is 1 cm, and the length of the second connecting segment l₄ is 1.5 cm, in which the width d₁ of the slit 141 is 0.5 cm.

Refer to the curve diagram of FIG. 4, the left longitudinal axis indicates the reflection coefficient (unit: dB), the right longitudinal axis indicates the Axial Ratio (A.R., unit: dB), of the long axis and short axis of the polarized electromagnetic wave, the horizontal axis indicates the operating frequency (unit: GHz). The Axial Ratio is an indicator used to measure whether the electromagnetic achieving the degree of circular polarization. If the polarized electromagnetic wave is more circular, the Axial Ratio is closer to 0 dB.

By the curve line C₁ in the curve diagram, the dual band antenna with circular polarization 100 in this embodiment may be operated in the first band at 1.2 GHz to 1.25 GHz and the second band at 1.6 GHz to 1.7 GHz band, to achieve dual-band operation results. Impedance and Voltage Standing Wave Ratio (VSWR) indicate the input impedance of antenna directly affect the emission efficiency of antenna, whereby the measurement results show that VSWR is 2:1. It represent the reflected power of the dual band antenna with circular polarization will consume the total transmit power 11%, therefore, it only allow 10% of energy for reflection. The curve line C₂ in the curve diagram shows the circular polarized effect of the dual band antenna with circular polarization. The curve diagram has a straight dotted line; it indicates A.R. is 3 dB, which represents the better the ratio of the circularly polarized wave effect.

In summary, the dual band antenna with circular polarization in the embodiment is a radiation metal portion which has a meandering structure attached on the surface and vertically placed on a substrate. The substrate is a circuit board which can be made of low-cost glass fiber FR4, and make the vacant area etched on circuit board to achieve dual-band operation results. The impedance matching and radiation efficiency on the resonant mode will make the dual band antenna with circular polarization be operated on two bands. The radiation metal portion having a meandering structure can also be effective for circularly polarization. In addition, the structural size and design of the dual band antenna with circular polarization can effectively save the space occupied of the antenna on a handheld apparatus, then achieving the effect that can built in handheld apparatus such as a guidance station, a smart phone, a notebook computer and a tablet personal computer.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art.

The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the is reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A dual band antenna with circular polarization comprising:
a substrate having a vacant area and a feed-in point, wherein the feed-in point is disposed outside the vacant area;
a radiation metal portion, disposed vertically to a surface of the substrate at an edge of the vacant area, comprising a radiation surface and a meandering structure, wherein the radiation surface is disposed at one side of the radiation metal portion near the substrate, and the meandering structure is disposed at another side of the radiation metal portion far from the substrate; and
a feed-in stripline disposed on the substrate, wherein one end point of the feed-in stripline is electrically connected to the feed-in point, and the other end point of the feed-in stripline is electrically connected to the radiation metal portion,
wherein, the meandering structure comprises a first line segment, a second line segment, a third line segment, a first connecting segment and a second connecting segment; the first line segment, the second line segment and the third line segment are mutually parallel; the first line segment and the second line segment are interconnected with the first connecting segment; the second line segment and the third line segment are interconnected with the second connecting segment; and the third line segment is disposed between the first line segment and the second line segment.

2. The dual band antenna with circular polarization of claim 1, wherein the substrate is substantially rectangular and has two first long sides parallel to each other and two first short sides parallel to each other, and the vacant area is a rectangular area located in a corner of the substrate, the rectangular area has two second long sides parallel to each other and two second short sides parallel to each other, and the two first long sides are parallel to the two second long sides, while the two first short sides are parallel to the two second short sides.

3. The dual band antenna with circular polarization of claim 2, wherein the two second long sides of the vacant area is ranged from 30 cm to 50 cm in length, the two second short side thereof is ranged from 8 cm to 15 cm in length, and the effect of dual band operation and the impedance matching at the resonant modes of the dual band antenna with circular polarization can be controlled by adjusting the size of the vacant area.

4. The dual band antenna with circular polarization of claim 1, wherein the substrate is a circuit board and a bottom surface thereof has a ground metal layer, wherein the ground metal layer does not overlap with the vacant area and the feed-in point is disposed on an upper surface of the circuit board opposite to the ground metal layer.

5. The dual band antenna with circular polarization of claim 1, wherein the meandering structure has a slit and is meandered in the shape of a paper clip, the slit is meandered along with the meandering direction of the meandering structure and forms an opening at the edge of the radiation metal portion, thereby separating the first line segment, the second line segment and the third line segment with the slit.

6. The dual band antenna with circular polarization of claim 1, wherein the meandering structure is disposed on the radiation metal portion opposite to a upper edge of the substrate.

7. The dual band antenna with circular polarization of claim 1, wherein the meandering structure is meandered in a clockwise direction to form a paper clip shape, so as to enable the dual band antenna with circular polarization to be used for the left rotation polarized.

8. The dual band antenna with circular polarization of claim 1, wherein the meandering structure is meandered in a counterclockwise direction to form a paper clip shape, so as to enable the dual band antenna with circular polarization to be used for the right rotation polarized.

9. The dual band antenna with circular polarization of claim 1, wherein the meandering structure has a total meandering length equal to the sum of the lengths of the first line segment, the second line segment, the third line segment, the first connecting segment and the second connecting segment, and the resonant frequency of the dual band antenna with circular polarization can be controlled by adjusting the total meandering length,.

10. The dual band antenna with circular polarization of claim 1, wherein the feed-in stripline has a width and a length, and the dual band antenna with circular polarization can be operated on a first frequency band and a second frequency band, wherein the impedance matching effect of the first frequency band and the second frequency band can be controlled by adjusting the width and the length of the feed-in stripline.
